(19) United States
(12) Patent Application Publication
(10) Pub. No.: US 2025/0299298 A1
(43) Pub. Date: Sep. 25, 2025

(54) PATTERN MODELING SYSTEM AND PATTERN MODELING METHOD

(71) Applicant: Samsung Electronics Co. Ltd., Suwon-si (KR)

(72) Inventors: Gun HUH, Suwon-si (KR); Eunju KIM, Suon-si (KR); Jaewon YANG, Suwon-si (KR)

(73) Assignee: Samsung Electronics Co., LTD, Suwon-si (KR)

(21) Appl. No.: 18/614,145

(22) Filed: Mar. 22, 2024

(51) Int. Cl. G06T 5/20

(52) U.S. Cl. CPC G06T 5/20; G06T 2207/20081; G06T 2207/20084

(57) ABSTRACT

A pattern modeling method of predicting image data includes generating first image data based on a sample pattern that is learned by a deep neural network (DNN), generating second image data by measuring the first image data, determining an area of the second image data to which a weight filter is to be applied, training the DNN by applying the weight filter to the determined area of the second image data, and predicting at least one pattern image based on a result of the training of the DNN.

### CROSS-REFERENCE TO RELATED APPLICATION

This application is based on and claims priority under 35 U.S.C. § 119 to Korean Patent Application No. 10-2023-0039293, filed on Mar. 24, 2023, in the Korean Intellectual Property Office, the disclosure of which is incorporated by reference herein in its entirety.

### BACKGROUND

The present disclosure related to a pattern modeling system and a pattern modeling method, and in particular, to a system and a method capable of performing training of a pattern modeling system by applying a weight filter.

A photomask may be used to print an integrated circuit (IC) layout on a wafer in a photolithography process in the manufacture of semiconductor devices. The photolithography process may generally use a method of transferring mask patterns formed on the photomask to the wafer through an optical lens. The photomask may include a transparent area and an opaque area. The transparent area may be formed by etching a metal layer on the photomask and light may be passed therethrough. On the other hand, the opaque area may not pass light therethrough. The mask patterns may be formed by the transparent area and the opaque area. Light emitted by a light source may be emitted onto the wafer through the mask patterns of the photomask, and accordingly, the IC layout may be printed on the wafer.

As the degree of integration of semiconductor devices increases, distances between the mask patterns of the photomask may become shorter, and a width of the transparent area may become very narrow. Due to this proximity, interference and diffraction of light may occur, and accordingly, a distorted layout different from a desired layout may be printed on the wafer.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided is a pattern modeling system capable of increasing the prediction of measurement data.

Additional aspects will be set forth in part in the description which follows and, in part, will be apparent from the description, or may be learned by practice of the presented embodiments.

According to an aspect of an example embodiment, a pattern modeling method of predicting image data may include generating first image data based on a sample pattern that is learned by a deep neural network (DNN), generating second image data by measuring the first image data, determining an area of the second image data to which a weight filter is to be applied, training the DNN by applying the weight filter to the determined area of the second image data, and predicting at least one pattern image based on a result of the training of the DNN.

According to an aspect of an example embodiment, a pattern modeling system for predicting image data may include a memory storing instructions, and at least one processor configured to execute the instructions to generate first image data based on a sample pattern that is learned by a DNN, the DNN comprising a plurality of layers, generate second image data by measuring the first image data, determining an area of the second image data to which a weight filter is to be applied, train the DNN by applying the weight filter to the determined area of the second image data, and predict at least one pattern image based on a result of the training of the DNN.

According to an aspect of an example embodiment, a non-transitory computer-readable storage medium may store instructions that, when executed by at least one processor, cause the at least one processor to generate first image data based on a sample pattern that is learned by a DNN, the DNN comprising a plurality of layers, generate second image data by measuring the first image data, determining an area of the second image data to which a weight filter is to be applied, train the DNN by applying the weight filter to the determined area of the second image data, and predict at least one pattern image based on a result of the training of the DNN, the weight filter is applied to an area corresponding to a feature portion of the second image data.

### BRIEF DESCRIPTION OF DRAWINGS

Additional aspects will be set forth in part in the description which follows and, in part, will be apparent from the description, or may be learned by practice of the presented embodiments, taken in conjunction with the accompanying drawings in which:

FIG. 1 is a block diagram of a pattern modeling system according to an embodiment;

FIG. 2 is a block diagram of a pattern modeling system according to an embodiment;

FIG. 3 is a flowchart illustrating a modeling method performed by a pattern modeling system according to an embodiment;

FIG. 4 is a diagram illustrating a method of generating first image data according to an embodiment;

FIG. 5 is a diagram illustrating a method of determining a weight filter area (WFA) in second image data according to an embodiment;

FIG. 6A is a diagram illustrating a method of determining a WFA according to an embodiment;

FIG. 6B is a diagram of an image to which the WFA is applied according to an embodiment;

FIG. 6C illustrates an example of generating first image data and second image data from a sample pattern according to an embodiment;

FIG. 7 illustrates a simulation result of applying a weight filter according to an embodiment;

FIG. 8 illustrates an example of a loss function module according to an embodiment;

FIG. 9 illustrates an example of a deep neural network (DNN) according to an embodiment;

FIG. 10 is a diagram illustrating an application example of a pattern modeling system according to an embodiment;

FIG. 11 is a flowchart illustrating a manufacturing method of a semiconductor device using a pattern modeling system according to an embodiment; and

FIG. 12 is a flowchart illustrating manufacturing method of an integrated circuit (IC) according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

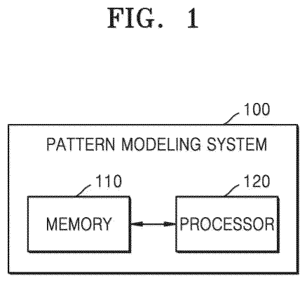

FIG. 1 is a block diagram of a pattern modeling system 100 according to an embodiment. As shown in FIG. 1, the pattern modeling system 100 may include a memory 110 and a processor 120. However, the configuration shown in FIG. 1 is an example for implementing the embodiments, and other hardware and software configurations may be additionally included in the pattern modeling system 100 as will be understood to one of ordinary skill in the art from the disclosure herein. According to an example, the pattern modeling system 100 may be implemented in the form of an electronic device.

The pattern modeling system 100 according to the disclosure may be applied in a simulation operation of a semiconductor patterning process. According to an example, the semiconductor patterning process may be a photolithography process. The pattern modeling system 100 according to the disclosure may learn a simulation result of a sample pattern used in the semiconductor patterning process to generate image data having high, accurate prediction with respect to a critical dimension (CD), etc. According to the disclosure, the pattern modeling system 100 may include a learning model, and may be trained by applying an image to which a weight filter is applied to a specific area. Through this, the pattern modeling system 100 may generate image data with high, accurate prediction with respect to the specific area.

The memory 110 may store commands or data related to at least one other component of the pattern modeling system 100. Also, the memory 110 may be accessed by the processor 120, and reading/writing/modifying/deleting/updating of data may be performed by the processor 120.

In the disclosure, the term memory may include the memory 110, a read-only memory (ROM) or a random access memory (RAM) in the processor 120, or a memory card (e.g., a micro secure digital (SD) card or a memory stick) mounted in the pattern modeling system 100. In addition, the memory 110 may store programs and data for configuring various screens to be displayed on a display area of a display.

According to an example, the memory 110 may include a non-volatile memory capable of maintaining stored information even if power supply is interrupted, and a volatile memory requiring continuous power supply to maintain stored information. For example, the non-volatile memory may be implemented as at least one of one time programmable ROM (OTPROM), programmable ROM (PROM), erasable and programmable ROM (EPROM), electrically erasable and programmable ROM (EEPROM), mask ROM, or flash ROM, and the volatile memory may be implemented as at least one of dynamic RAM (DRAM), static RAM (SRAM), or synchronous dynamic RAM (SDRAM).

According to an example, the memory 110 may store a pre-trained neural network model. The pre-trained neural network model may be a model transmitted to the pattern modeling system 100 after being trained in an external server. Alternatively, the pre-trained neural network model may be a model trained within the pattern modeling system 100. The neural network model may include a plurality of layers and may include weight data learned by a server. According to an example, the neural network model may be a generative adversarial network (GAN) model. In the disclosure, expressions of a neural network model and a learning model may be used interchangeably.

The processor 120 may be electrically connected to the memory 110 to control all operations and functions of the pattern modeling system 100. The processor 120 may obtain a loss function using output data obtained by inputting training data to the pre-trained neural network model stored in the memory and a label corresponding to the training data. The label may refer to an actual value to be output when the training data is input to the neural network model, and the loss function may refer to a function that quantifies a difference between the output data and the label.

The processor 120 may obtain the magnitude of a weight variation of each of the plurality of layers included in the neural network model based on the loss function. The weight variation of each of the plurality of layers may refer to a value by which that the weight of each of the plurality of layers needs to be changed in order to minimize a value of the loss function. The magnitude of the weight variation may be expressed as a weight loss, the magnitude of a return derivative, or the magnitude of a differential value (e.g., L2 Norm value of a derivative).

The processor 120 according to the disclosure may calculate the loss function based on the image to which the weight filter is applied to the specific area, train the neural network model stored in the memory 110 based on the loss function, update the magnitude of the weight variation, and obtain the prediction of the specific area.

A function related to artificial intelligence (AI) according to the disclosure may be performed by the processor 120 and the memory 110. The processor 120 may include one processor or a plurality of processors. One processor or a plurality of processors may include a general-purpose processor, such as a central processing unit (CPU), an application processor (AP), a digital signal processor (DSP), etc., a graphic-dedicated processor, such as a graphics processing unit (GPU), a vision processing unit (VPU), etc., or an AI-dedicated processor, such as a neural processing unit (NPU).

The processor 120 or the plurality of processors 120 may process input data according to a predefined operation rule or an AI model stored in the memory 110. Alternatively, when the processor or a plurality of processors includes an AI-dedicated processor, the AI-dedicated processor may be designed to have a hardware structure specialized for processing a specific AI model.

The predefined operation rule or the AI model may be produced through training. When the AI model is produced through training, this may indicate that a basic AI model is trained based on a learning algorithm using multiple training datasets, such that the predefined operation rule or AI model set to execute desired characteristics (or purpose) is produced. Such training may be performed by a device on which an AI according to the disclosure is implemented, or by a separate server and/or system.

Examples of a learning algorithm may include, but not limited to, supervised learning, unsupervised learning, semi-supervised learning, or reinforcement learning.

The AI model may include a plurality of neural network models, and a neural network model may include a plurality of layers. Each of the plurality of neural network layers may have a plurality of weight values, and may perform a neural network operation through an operation between an operation result of a previous layer and the plurality of weight values. The plurality of weight values of the plurality of neural network layers may be optimized by a training result of the AI model. For example, the plurality of weight values may be updated to reduce or minimize a weight loss value (e.g., the magnitude of a weight variation) or a cost value obtained in the AI model during a training process.

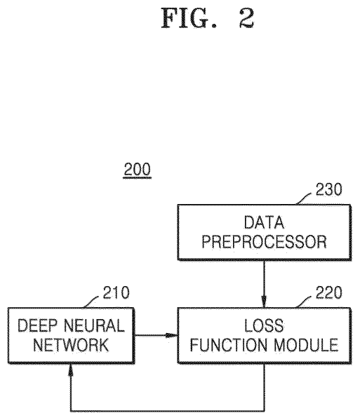

FIG. 2 is a block diagram of a pattern modeling system according to an embodiment.

Referring to FIG. 2, a pattern modeling system 200 may include a deep neural network (DNN) 210, a loss function module 220, and a data preprocessor 230. According to an example, the DNN 210 may include a learning model. According to an example, the DNN 210 may include a GAN model. The DNN 210 may include a generator that generates a fake image from input data and a classifier that identifies the fake image. For example, the generator may output the fake image and the classifier may output the probability of being a real image (or the probability of being the fake image). The classifier may be trained to identify the fake image based on the real image and the fake image, and the generator may be trained to identify the fake image generated thereby as the real image. Accordingly, the trained generator may generate a fake image that is very similar to the real image.

For example, input data received by the generator may be images extracted from layout data obtained by designing patterns to be formed through a semiconductor process. The generator may generate patterns expected to be formed on a semiconductor substrate as an output image by performing the semiconductor process based on the layout data using the input data. The classifier may compare the output image to a pattern image. The pattern image may be an image of actual patterns formed by performing a semiconductor process based on layout data to which an optical proximity correction model is applied, and may be a scanning electron microscope (SEM) image or a transmission electron microscopy (TEM) image.

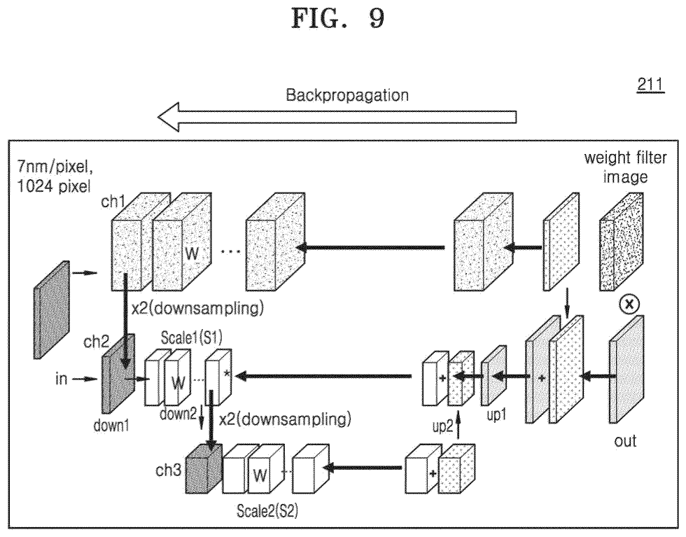

The DNN 210 may include a plurality of layers, and weight data between the plurality of layers may be updated by the loss function module 220. The loss function module 220 may be configured as a processing component that implements various operations corresponding to a loss function as is described in detail throughout the specification (e.g., this is described below in detail with reference to FIG. 9). In the disclosure, a DNN and a deep learning network may be used interchangeably. According to an example, data learned by the DNN 210 may be expressed as training data.

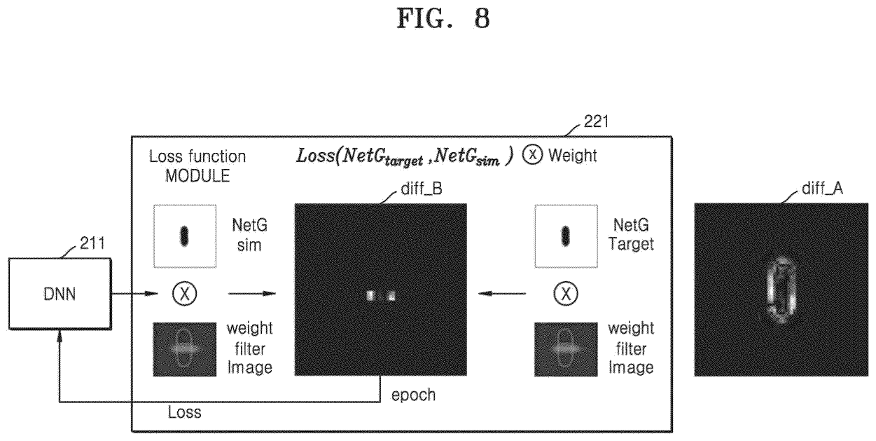

According to an example, the loss function module 220 may calculate a difference between image data learned by the DNN 210 and image data processed by the data preprocessor 230, and transfer the difference to the DNN 210. According to an example, image data to be calculated in the loss function module 220 may be image data to which a weight filter is applied by the data preprocessor 230. This is described below in detail with reference to FIG. 8.

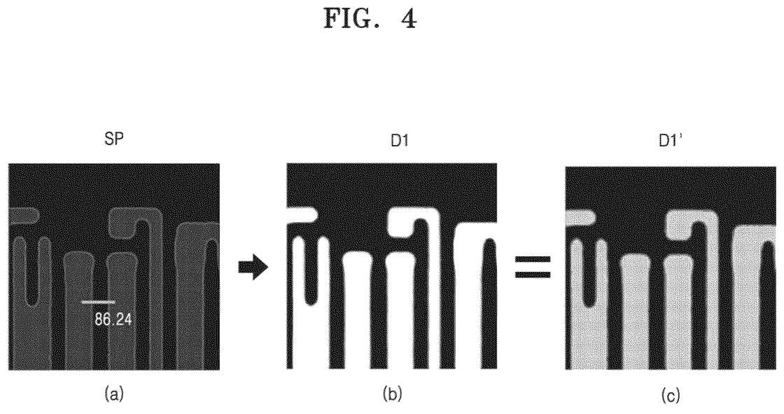

According to an example, the data preprocessor 230 may generate and preprocess data with respect to a sample pattern that is a learning target of the pattern modeling system 200. According to an example, the data preprocessor 230 may generate image data corresponding to the sample pattern and determine an area of the generated image data to which a weight filter is to be applied. The data preprocessor 230 may determine the area to which the weight filter is applied and apply the weight filter to the generated image data. This is described in detail with reference to FIGS. 4A to 7.

According to an example, the image data that is the learning target of the pattern modeling system 200 may include at least one of a design layout, a resist image, an aerial image, a slope map, a density map, or a photon map. The design layout may refer to a bitmap image configured as a target pattern to be implemented on a wafer or an image in any other appropriate format. The resist image may be an image of a photoresist derived by simulation from the design layout. The aerial image may be an image representing the intensity distribution of exposure light reaching the photoresist derived from the design layout. The slope map may be an image in which a value of each pixel included in the slope map is a gradient of each pixel of the aerial image. The density map may be an image in which a bit value of a specific pixel is determined by a pattern density in the vicinity of the specific pixel. The photon map may be an image obtained by simulating the number of photons to reach each pixel in an exposure process.

The design layout, the resist image, the aerial image, the slope map, the density map, or the photon map in a training operation of the DNN 210 may be referred to as a training data set in some cases. The training data set may be related to a design layout already transferred onto a wafer and may include an SEM image.

According to an example, a semiconductor process may be performed based on layout data. Various patterns may be formed on a semiconductor substrate by an exposure process of transferring layout data to generate a mask, and an etching or deposition process using the mask generated in the exposure process. To minimize differences between the layout data and the patterns formed on the semiconductor substrate, proximity correction may be applied. According to the disclosure, the pattern modeling system 200 may learn image data capable of minimizing the differences and generate prediction data in order to reduce an error when performing proximity correction. When receiving the sample pattern, the pattern modeling system 200 according to the disclosure may predict an nano geometry research (NGR) measurement image corresponding to the corresponding pattern. According to the disclosure, in order to generate a model for better predicting a CD of a specific main pattern while using a deep learning model training method, the pattern modeling system 200 may perform training by applying the weight filter described in the disclosure, such that the deep learning model may increase the predictive power of the CD of measurement data. The measurement data may be data measured by the sample pattern included in the pattern modeling system 200. The measurement data may reflect results that the pattern modeling system 200 has learned. The pattern modeling system 200 according to the disclosure may generate a deep learning model that maintains an accurate CD value of an anchor pattern or a specific position.

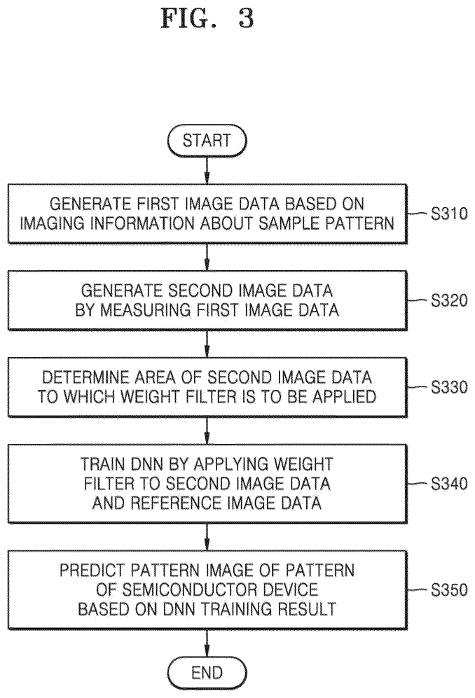

FIG. 3 is a flowchart illustrating a modeling method performed by a pattern modeling system according to an embodiment.

In operation S310, first image data may be generated based on imaging information about a sample pattern. The sample pattern may be a pattern for generating an image that is a learning target of the pattern modeling system. The sample pattern may be a pattern of a photomask that is a prediction target of the pattern modeling system. The shape of the sample pattern is not limited to a specific shape, and may be provided in various shapes. The first image data may refer to image data that may be formed by the sample pattern. According to an example, the first image data may be image data obtained by simulating the sample pattern.

In operation S320, second image data may be generated by measuring the first image data. According to an example, the first image data may be image data obtained by simulating a photolithography process using the sample pattern. The second image data may be image data obtained as a result of performing a simulation measurement by applying various conditions to the first image data. According to an example, the second image data may be image data obtained as a result of measuring the first image data by variously applying a process condition, a focus position, a dose, etc. to the first image data.

According to an example, in operation S310 or operation S320, the first image data and the second image data may be image data obtained by converting a target layout or a measurement contour image into a dithering image.

In operation S330, an area of the second image data to which a weight filter is to be applied may be determined. In the disclosure, the area to which the weight filter is to be applied may be described interchangeably with terms such as a weight filter area (WFA). The area to which the weight filter is to be applied may refer to an area to be learned by the pattern modeling system of the disclosure with a higher weight. According to an example, the area to which the weight filter is to be applied may be different according to characteristics of the second image data. According to an example, the area to which the weight filter is to be applied may be an anchor pattern. Alternatively, the area to which the weight filter is to be applied may be any one of main patterns included in the modeling system. Alternatively, the area to which the weight filter is to be applied may be an area in which a large distribution is displayed. The area to which the weight filter is to be applied is not standardized, and may be part of image data that is desired to be emphasized and learned.

In operation S340, DNN training may be performed by applying the weight filter to the second image data and reference image data. According to an example, when the area to which the weight filter is to be applied is determined, a weight image filter to which a weight is applied to the corresponding area may be generated. According to an example, the reference image data may be the first image data or pre-stored sample image data. Alternatively, the reference image data may be comparison target data output through training. According to an example, a loss function may be determined by applying the weight filter to a difference between the reference image data and the second image data, and DNN training may be performed. Through this, training may be performed by applying a weight filter to the area.

In operation S350, a pattern image of a pattern of a semiconductor device may be predicted based on a DNN training result. According to an example, the pattern image obtained as the DNN training result with respect to the sample pattern may be an image with a higher accuracy with respect to the area to which the weight filter is to be applied than before training.

Referring to FIG. 3, with respect to the image data obtained through simulation of the sample pattern, the area to which the weight filter is to be applied may be determined, and loss function calculation and DNN training may be performed based on the image data to which the weight filter is applied. Through this, prediction data with high accuracy with respect to the sample pattern may be output, and the prediction of the pattern image may be sufficiently secured.

FIG. 4 is a diagram illustrating a method of generating first image data according to an embodiment.

Referring to FIG. 4, (a) illustrates an example of a sample pattern SP, while (b) and (c) illustrate first image data D1 and D1′ generated from the sample pattern SP.

According to an example, the sample pattern SP may be provided by a designed mask layout. The mask layout may include the sample pattern SP required for printing an integrated circuit (IC) on a wafer. The sample pattern SP may define a planar shape of cell patterns to be formed in a cell array area of the wafer.

According to an example, image data generated by the sample pattern SP may be images obtained through an SEM. According to an example, an SEM image may be generated from NGR equipment or SEM equipment manufactured by NGR, Inc. The SEM image may be an image of a photoresist pattern generated by after development inspection (ADI) or an image of an actual circuit pattern generated by after clean inspection (ACI).

In the sample pattern SP of (a), it may be confirmed that a CD is measured as 86.24. According to an example, in (b), an ACI (ADI) contour image for training may be generated from the sample pattern SP. According to an example, the ACI (ADI) contour image for training of (b) may be transferred as a layout file in NGR (SEM) equipment. The layout file may be a graphic design system (GDS) file. For deep learning training, a dithering process of converting the layout file into image data may be necessary. Through this, the first image data D1′ of (c) may be generated. That is, the first image data D1′ of (c) may be image data obtained by dithering the GDS file.

According to an example, while dithering is performed from the GDS file to the image data, coordinate information, which is a location where the CD is measured, disappears. The GDS file displays information of all polygons as coordinates, but the image data is expressed in pixels, and thus, the coordinate information appears.

Accordingly, measurement coordinate information may not be included in the generated first image data D1 and D1′. According to an example, when the coordinate information that has disappeared is an anchor pattern responsible for a process reference, accurately predicting CD of the corresponding location is an important performance indicator for model predictive power, and training may be required by emphasizing the CD of the corresponding location.

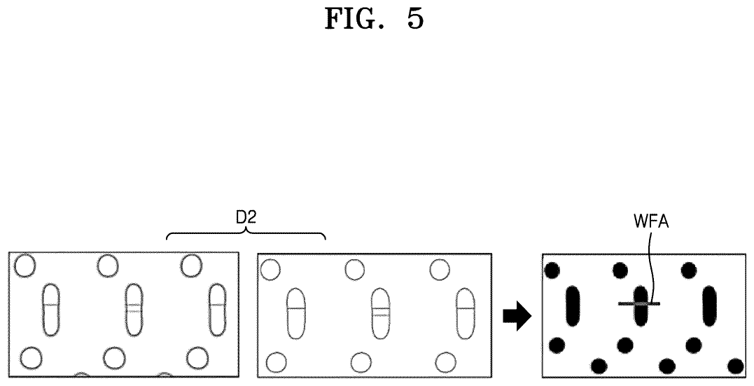

FIG. 5 is a diagram illustrating a method of determining a WFA in second image data according to an embodiment.

According to an example, second image data D2 of FIG. 5 may be image data results obtained by applying measurement values to first image data. From the results of the second image data D2, an area to which a weight filter is to be applied may be selected. In an example of FIG. 5, the WFA is shown. Referring to the example of FIG. 5, the WFA may refer to a CD area that may be measured in the second image data D2.

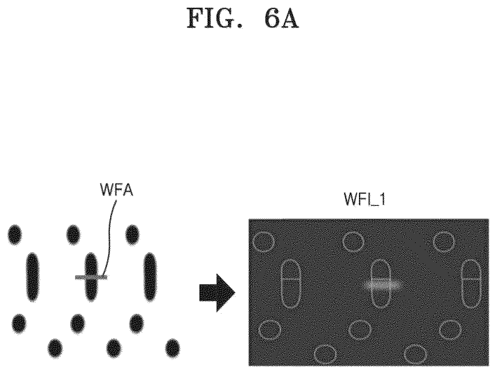

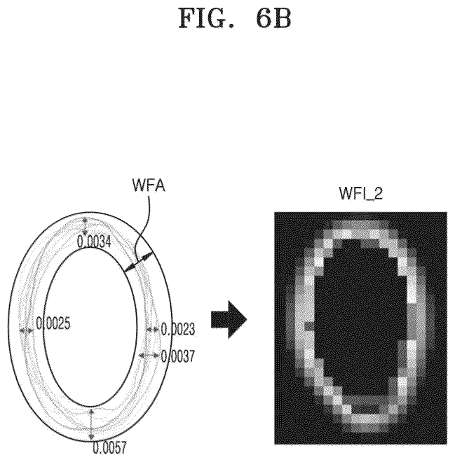

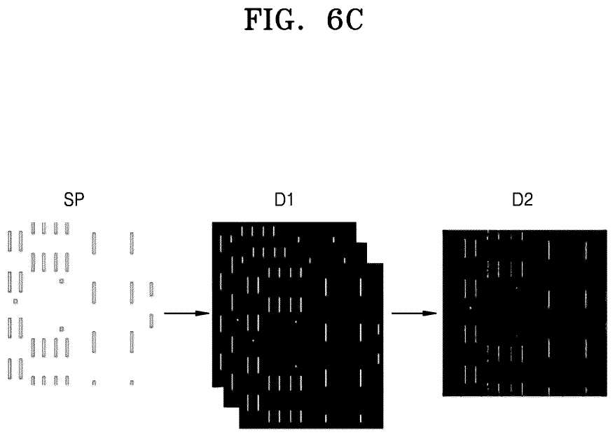

FIG. 6A is a diagram illustrating a method of determining a WFA according to an embodiment. FIG. 6B is a diagram of an image to which the WFA is applied according to an embodiment.

Referring to FIG. 6A second image data to which the WFA is applied is shown on the left, and image data WFI_1 obtained by applying the WFA to the second image data is shown on the right. In FIG. 6B, second image data to which the WFA is applied is shown on the left, and image data WFI_2 obtained by applying the WFA to the second image data is shown on the right.

Referring to FIG. 6A, an example of determining an area corresponding to a CD as the WFA when measuring the CD in the second image data is shown.

Referring to FIG. 6B, an example of determining an area in which a plurality of distributions are distributed as the WFA when a distribution is measured in the second image data is shown.

Referring to FIGS. 6A and 6B, when the WFA is determined in the second image data, the weight filter images WFI_1 and WFI_2 to which the determined WFA is applied may be generated. The examples of setting the WFA shown in FIGS. 6A and 6B may correspond to some of the embodiments. According to an example, when setting the WFA, a sample pattern may be set to have different locations and backgrounds. According to another example, the WFA may be set to be the same as the location of a measurement point. According to another example, the WFA may be set to correspond to a shape of a specific pattern. According to another example, a weight to be applied to the set WFA may be adjusted.

FIG. 6C illustrates an example of generating first image data and second image data from a sample pattern according to an embodiment.

Referring to FIG. 6C, the sample pattern SP may be provided in a design form, and a plurality of pieces of first image data D1 may be generated by the sample pattern SP. When the plurality of pieces of first image data DI is generated, the second image data D2 may be generated by measuring the plurality of pieces of first image data D1.

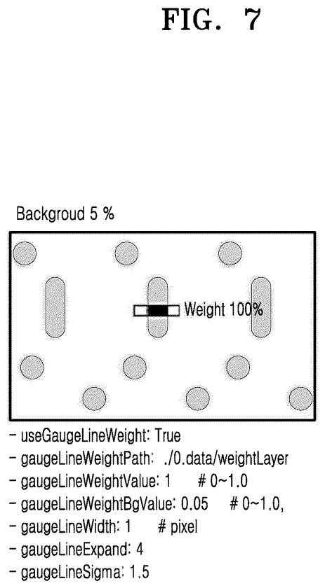

FIG. 7 illustrates a simulation result of applying a weight filter according to an embodiment.

Referring to FIG. 7, image data to which a weight is applied to a desired part may be generated by generating an image in which 100% of the weight is reflected in the center of the image and only 5% of the weight is reflected in the background.

According to an example, in order to reflect the weight on a specific location of the image data, coordinates of a GDS may first be changed to pixel positions. To automate this, measurement images and dithering images may be indexed. Thereafter, dithering images having the same index and measurement coordinates may be changed to pixel positions.

According to the disclosure, a weight layer image corresponding to the weight filter may be generated. The weight layer image may be generated in the form of gray levels 0 to 255. This is to multiply a measurement dithering image and each pixel. Gray levels may store values of 0 to 255 (256) in each pixel as integers, and the values of 0 to 255 (256) may be easily normalized to 0 to 1.

That is, according to the disclosure, the weight layer image may be used to convolute the measured dithering image and perform normalization. According to an example, when a user intuitively sets a weight value, the weight value may be set to a normalized value between 0 and 1. Finally, when a weight filter is applied to only a measurement pixel of a weight layer to multiply a dithering image of a measurement contour by the weight layer image, only an image of a measurement part may remain as a training result. Therefore, a background value may be required to be reflected when the weight layer image is generated.

Referring to FIG. 7, the weight filter image may be generated by setting the weight to 100% and the background value to 5% in a WFA, and specific values may be adjusted.

Then, deep convolutional GAN (DCGAN) training may be performed using the corresponding image data. According to the disclosure, optical proximity correction (OPC) and process proximity correction (PPC) may be performed using trained data. That is, OPC and PPC prediction models may be generated utilizing deep learning that effectively matches CDs of an anchor pattern and an important pattern.

FIG. 8 illustrates an example of a loss function module according to an embodiment. Referring to a loss function module 221 of FIG. 8, a difference value may be transferred to a DNN 211. The loss function equation implemented by the loss function module 221 of FIG. 8 may be expressed by Equation (1).

$$Loss ( {Net G}_{target} , {Net G}_{sim} ) \times Weight \qquad ( 1 )$$

According to an example, NetGtarget may be second image data obtained as a measurement result, and NetGsim may be reference image data. Weight may refer to a weight layer image to which a WFA is applied. According to an example, a weight filter may be applied to a difference value between the second image data and the reference image data. According to an example, a difference value diff_B obtained by convolving the second image data with the weight filter image and convolving the reference image data with the weight filter image may be transferred to the DNN 211. According to an example, the weight filter image applied to the second image data may be the same as the weight filter image applied to the reference image data.

According to the disclosure, a weight filter image of a specific part of an extracted area may be generated in accordance with an input size and used as a loss function for backpropagation of the DNN 211 to reflect the weight of a specific pixel area. According to an example, when changing an image of a contour layout for image-to-image training, an engineer may select an area that has been measured or a desired area, and generate a weight filter image of the same size as an additional input image with respect to the selected area.

The generated weight filter image may be used when comparing a simulation image generated as an output after forward training of the DNN 211 is performed with a discriminator image. According to an example, the simulation image may be a fake image, and the discriminator image may be a real image. According to an example, the simulation image may be the reference image data, and the discriminator image may be the second image data. When there is no weight filter image, a difference image diff_A may be generated, but the difference value diff_B of an area of interest to the user may be generated using the weight filter image. As a result of application of the loss function by the loss function module 221, weight data between layers may be updated through GAN backpropagation.

According to the disclosure, a model training methodology of generating a weight filter with respect to a position of an image pixel and using the weight filter for training during image deep learning modeling of a semiconductor patterning process is provided. According to the disclosure, in a process of training deep learning modeling based on the image data, a weight filter with respect to a specific pattern or a specific area may be generated and used to adjust a pixel weight of each area, which may be used to improve model accuracy and expand data mining.

FIG. 9 illustrates an example of a DNN according to an embodiment. According to an example, the DNN 211 may include a plurality of layers ch1, ch2, ch3 . . . Weight data W may be reflected between the plurality of layers ch1, ch2, ch3 . . . The weight data W of the DNN 211 according to the disclosure may be updated through a result of applying a weight filter image to output data out of the DNN 211.

The DNN 211 according to the disclosure may have a structure that allows pixel correlation over a long distance by including a plurality of down sample layers. Because the down sample layer implies pattern information, each time the down sample layer passes a pixel, an input image may be halved in an output layer. However, the reduced image still corresponds to the same area as the input image, and information represented may correspond to twice (or 4 times in reference to area) of the input image. As a result, even when a kernel of the same size is used, a kernel acting on an image that has passed more down sample layers may express pixel correlation with respect to a wider area. For example, when an image of a first down sample layer is about ¼ ( 1/16 in the concept of area) of the input image, a kernel corresponding to a second down sample layer may cover a very small area in the input image, but may cover most of the area in an image of the second down sample layer.

The DNN 211 according to the disclosure may reflect the influence of patterns located far away, and the output image may generate a high precision image that may guarantee accuracy of a sub-pixel level. According to the disclosure, pattern complexity is different for each layer of a semiconductor device, and thus, modeling may be possible by changing an architecture.

An image based model through the DNN 211 according to the disclosure may be capable of one-to-one training and may be trained to predict one answer. According to the disclosure, in order to induce training to match a specific CD or to better predict an area with poor distribution, a loss function may be configured using the weight filter, which is an additional tool between a real image and a generated image. According to an example, when using newly processed data for training, the DNN 211 according to the disclosure may use only an area suitable for data consistency for training.

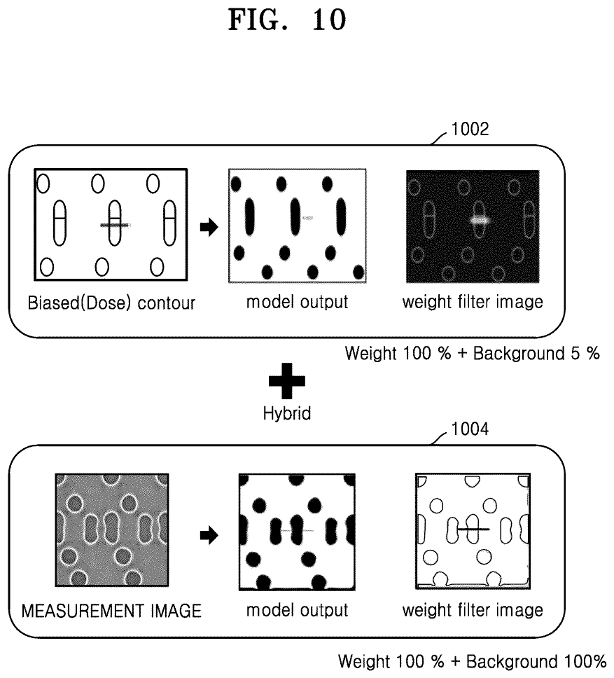

FIG. 10 is a diagram for explaining an application example of a pattern modeling system according to an embodiment. Referring to FIG. 10, the pattern modeling system according to the disclosure may be capable of deep learning modeling of patterns having few measurement images.

Referring to FIG. 10, a deep learning model may be generated in a situation where there are only measurement results and a small number of measurement images. According to the disclosure, the pattern modeling system according to the disclosure may be applied to use a simulation image with respect to a specific pattern having no measurement image or to generate a model that increases the predictive accuracy of a CD or a pattern shape in a specific area.

1002 of FIG. 10 illustrates a case where only contour images exist, and 1004 of FIG. 10 illustrates a case where measurement images exist but the number thereof is small. When measurement images exist but the number thereof is insufficient for training, repetitive training may be performed on an area of a measurement image in which a weight filter is used. According to an example, training may be performed by setting high weight and background values to a measurement image and low a background value to a contour image.

According to an example, assuming that 259 measurement images exist and 1984 CD values are measured by simulation during modeling, when training is performed by setting all pixels of the CD values configured by simulation to the same weight, an overfitting problem may arise. In this case, according to the disclosure, training may be performed on the generated patterns with respect to the measured CD values, and model training may be performed in a hybrid form together with a sample having an existing measurement image.

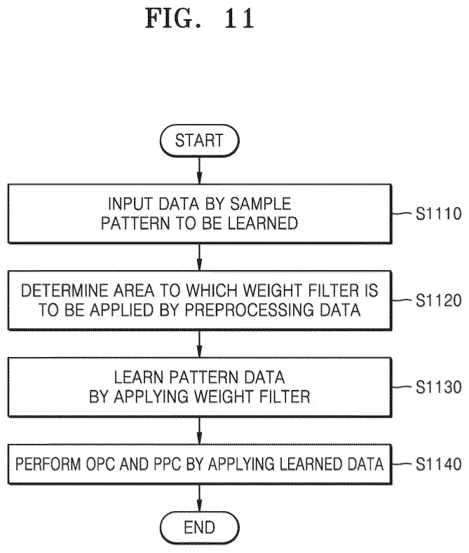

FIG. 11 is a flowchart illustrating a manufacturing method of a semiconductor

device using a pattern modeling system according to an embodiment.

In operation S1110, data by a sample pattern to be learned may be input. In this case, the input data may be first image data generated based on the sample pattern.

In operation S1120, an area to which a weight filter is to be applied may be determined by preprocessing the data. According to an example, preprocessing of the data may include generating the first image data and generating second image data by measuring the first image data. Determining of the area to which the weight filter is to be applied may be determined according to characteristics of the second image data.

In operation S1130, pattern data may be learned by applying the weight filter. In operation S1130, image data to which the weight filter is applied may be applied to a loss function.

In operation S1140, OPC and PPC may be performed by applying the learned data. The learned data has higher accuracy with respect to the area to which the weight filter is applied, and thus, OPC and PPC may be more efficiently performed on the learned data.

OPC and PPC may be performed based on lithography simulation predicting a contour image to be formed on a wafer from a designed mask layout and a CD.

According to the disclosure, in order to change (reflect) the weight of a specific location of an image during deep learning modeling, a weight filter image in units of pixels may be set. The weight filter image may be image data for training to which the weight filter is applied. According to an example, the weight filter image may be set as the loss function during deep learning training and used for updating weights during backpropagation calculation.

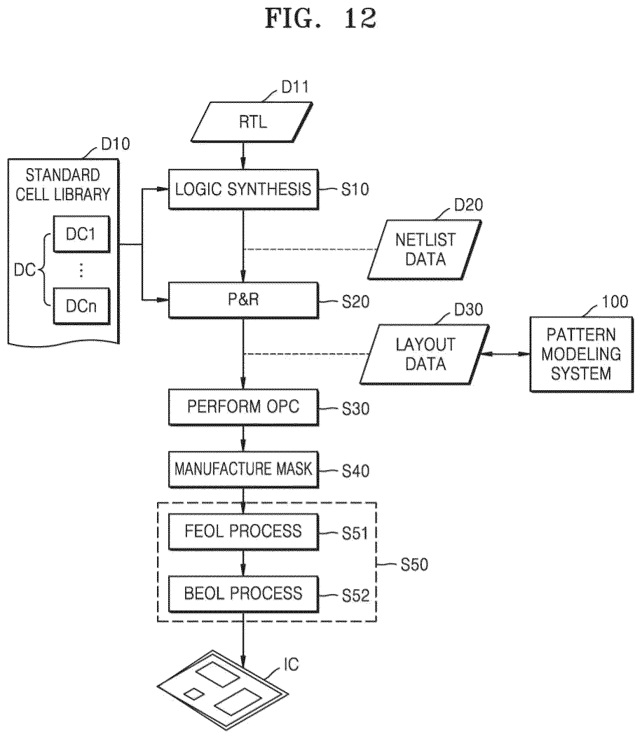

FIG. 12 is a flowchart illustrating a method of fabricating an IC according to an embodiment.

Referring to FIG. 12, a standard cell library D10 may include information about standard cells, for example, function information, characteristic information, layout information, etc. The standard cell library D10 may include data DC defining a layout of a standard cell. The data DC may include data defining structures of standard cells that perform the same function and have different layouts. The data DC may include first data DC1 performing a first function and defining structures of standard cells having different layouts, and n-th data DCn (n is a natural number of 2 or more) performing an n-th function and defining structures of standard cells having different layouts.

In operation S10, a logic synthesis operation may be performed to generate netlist data D20 from ready to learn (RTL) data D11. For example, a semiconductor design tool (e.g., a logic synthesis module) may perform the logic synthesis operation with reference to the standard cell library D10 from the RTL data D11 written as very high speed IC (VHSIC) hardware description language (VHDL) and hardware description language (HDL) such as Verilog, thereby generating netlist data D20 including a bitstream or a netlist. An RTL design may be developed according to a design verification method and a computing system, and the RTL data D11 may be generated.

The standard cell library D10 may include the data DC performing the same function and defining structures of the standard cells having different layouts, and the standard cells may be included in the IC with reference to such information during logical synthesis.

In operation S20, a place & routing (P&R) operation of generating layout data D30 from the netlist data D20 may be performed. The layout data D30 may have a format such as, for example, GDSII, and may include geometric information of standard cells and interconnections.

For example, a semiconductor design tool (e.g., a P&R module) may place a plurality of standard cells with reference to the standard cell library D10 from the netlist data D20. The semiconductor design tool may select one of the layouts of standard cells defined by the layout data D103 with reference to the data DC, and may place the selected layout of the standard cells.

In operation S20, an operation of generating interconnections may be further performed. The interconnection may electrically connect an output pin and an input pin of a standard cell, and may include, for example, at least one via and at least one conductive pattern.

In operation S30, OPC may be performed. OPC may refer to an operation to form a pattern of a desired shape by correcting a distortion phenomenon such as refraction caused by characteristics of light in photolithography included in a semiconductor process for manufacturing an IC, and a pattern on a mask may be determined by applying OPC to the layout data D30. In some embodiments, a layout of the IC may be limitedly modified in operation S30, and limitedly modifying of the IC in operation S30 is post-processing to optimize the structure of the IC and may be referred to as design polishing. According to an embodiment, the layout data D30 may be layout data learned and predicted by the pattern modeling system 100 of FIG. 1. Using the layout data learned and predicted by the pattern modeling system 100, a result with higher pattern accuracy may be obtained.

In operation S40, an operation of manufacturing a mask may be performed. For example, as OPC is applied to the layout data D30, patterns on the mask may be defined to form patterns formed on a plurality of layers, and at least one mask (or, photomask) may be manufactured to form respective patterns of the plurality of layers.

In operation S50, an operation of manufacturing the IC may be performed. For example, the IC may be manufactured by patterning the plurality of layers using the at least one mask manufactured in operation S40. Operation S50 may include operations S51 and S52.

In operation S51, a front-end-of-line (FEOL) process may be performed. FEOL may refer to a process of forming individual elements, e.g., transistors, capacitors, resistors, etc., on a substrate during a manufacturing process of an IC. For example, the FEOL process may include planarizing and cleaning a wafer, forming trenches, forming wells, forming gate lines, and forming sources and drains.

In operation S52, a back-end-of-line (BEOL) process may be performed. BEOL may refer to a process of interconnecting individual elements, e.g., transistors, capacitors, resistors, etc., in the manufacturing process of the IC. For example, the BEOL process may include silicidating gate, source and drain areas, adding dielectric, planarizing, forming holes, forming metal layers, forming vias, and forming a passivation layer. Then, the IC may be packaged in a semiconductor package and used as a component in various applications.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., a program) including one or more instructions that are stored in a storage medium (e.g., internal memory or external memory) that is readable by a machine (e.g., an electronic device). For example, a processor of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” may indicate that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online through an application store (e.g., PlayStore™M), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Each of the embodiments provided in the above description is not excluded from being associated with one or more features of another example or another embodiment also provided herein or not provided herein but consistent with the disclosure

While the disclosure has been particularly shown and described with reference to embodiments thereof, it will be understood that various changes in form and details may be made therein without departing from the spirit and scope of the following claims.

What is claimed is:

1. A pattern modeling method of predicting image data, the pattern modeling method comprising:
generating first image data based on a sample pattern that is learned by a deep neural network (DNN);
generating second image data by measuring the first image data;
determining an area of the second image data to which a weight filter is to be applied;
training the DNN by applying the weight filter to the determined area of the second image data; and
predicting at least one pattern image based on a result of the training the DNN.

2. The pattern modeling method of claim 1, wherein the second image data comprises image data generated by applying a process condition to the first image data.

3. The pattern modeling method of claim 1, wherein the determining the area of the second image data to which the weight filter is to be applied comprises determining an area corresponding to a critical dimension of the second image data.

4. The pattern modeling method of claim 1, wherein the determining the area of the second image data to which the weight filter is to be applied comprises determining an area corresponding to a distribution of the second image data.

5. The pattern modeling method of claim 1, wherein the determining the area of the second image data to which the weight filter is to be applied comprises determining an area corresponding to a pattern shape of the second image data.

6. The pattern modeling method of claim 1, wherein the DNN is trained based on:
third image data obtained by convolving the weight filter with the second image data; and
fourth image data obtained by convolving the weight filter with reference image data.

7. The pattern modeling method of claim 6, wherein the training of the DNN comprises applying a difference between training data to which the weight filter corresponding to the area is applied and a loss function.

8. The pattern modeling method of claim 7, wherein the training the DNN further comprises updating weight data of the DNN based on a calculation result of the loss function.

9. A pattern modeling system for predicting image data, the pattern modeling system comprising:
a memory storing instructions; and
at least one processor configured to execute the instructions to:
generate first image data based on a sample pattern that is learned by a deep neural network (DNN), the DNN comprising a plurality of layers;
generate second image data by measuring the first image data;
determining an area of the second image data to which a weight filter is to be applied;
train the DNN by applying the weight filter to the determined area of the second image data; and
predict at least one pattern image based on a result of the training the DNN.

10. The pattern modeling system of claim 9, wherein the at least one processor comprises at least one data preprocessor, and
wherein the at least one data preprocessor is configured to execute the instructions to preprocess the image data based on the sample pattern.

11. The pattern modeling system of claim 10, wherein the first image data comprises image data obtained at least in part based on the sample pattern, and
wherein the second image data comprises image data obtained by applying a process condition to the first image data.

12. The pattern modeling system of claim 11, wherein the area to which the weight filter is to be applied comprises an area corresponding to a critical dimension (CD) of the second image data.

13. The pattern modeling system of claim 11, wherein the area to which the weight filter is to be applied comprises an area corresponding to a distribution of the second image data.

14. The pattern modeling system of claim 11, wherein the area to which the weight filter is to be applied comprises an area corresponding to a pattern shape of the second image data.

15. The pattern modeling system of claim 11, wherein the at least one data preprocessor is further configured to execute the instructions to:
apply the weight filter corresponding to the area to the second image data; and
transmit an image to which the weight filter is applied to a loss function module.

16. The pattern modeling system of claim 15, wherein the loss function module is configured to:
determine a difference between third image data generated based on applying the weight filter to the second image data and fourth image data generated based on applying the weight filter to reference image data, and
minimize the difference.

17. The pattern modeling system of claim 16, wherein the reference image data comprises output image data of the DNN.

18. A non-transitory computer-readable storage medium storing instructions that, when executed by at least one processor, cause the at least one processor to:
generate first image data based on a sample pattern that is learned by a deep neural network (DNN), the DNN comprising a plurality of layers;
generate second image data by measuring the first image data;
determining an area of the second image data to which a weight filter is to be applied;
train the DNN by applying the weight filter to the determined area of the second image data; and
predict at least one pattern image based on a result of the training the DNN,
wherein the weight filter is applied to an area corresponding to a feature portion of the second image data.

19. The non-transitory computer-readable storage medium of claim 18, wherein the feature portion comprises an area corresponding to a critical dimension of the second image data.

20. The non-transitory computer-readable storage medium of claim 18, wherein the feature portion comprises an area corresponding to a distribution of the second image data.
